(19) United States
(12) Patent Application Publication
(10) Pub. No.: US 2015/0021371 A1
(43) Pub. Date: Jan. 22, 2015

(54) CARGO ACCESSORY FOLDING MECHANISM

(71) Applicants: Brian Wayne Ward, Swartz Creek, MI (US); Gail Rae Matheus, Towanda, KS (US); Sean Michael Phillips, Huntsville (CA)

(72) Inventors: Brian Wayne Ward, Swartz Creek, MI (US); Gail Rae Matheus, Towanda, KS (US); Sean Michael Phillips, Huntsville (CA)

(73) Assignee: CEQUENT PERFORMANCE PRODUCTS, INC., Plymouth, MI (US)

(21) Appl. No.: 14/237,273

(22) PCT Filed: Aug. 1, 2012
(86) PCT No.: PCT/US2012/049151

§ 371 Date: Oct. 7, 2014

Related U.S. Application Data
(60) Provisional application No. 61/515,678, filed on Aug. 5, 2011.

(51) Int. Cl. B60R 9/06

(52) U.S. Cl. CPC B60R 9/06
USPC 224/499

(57) ABSTRACT

A folding mechanism for a cargo accessory is shown and described. The folding mechanism may include a linkage selectively attachable to a vehicle, and a cargo accessory carrying member pivotally attached to the linkage, where the cargo accessory carrying member is capable of locking engagement with the linkage. The folding mechanism may also include a release member operatively attached to the cargo accessory carrying member, where the release member is selectively axially positionable from a first position whereby the cargo accessory carrying member releases from the locking engagement with the linkage permitting pivoting of the cargo accessory carrying member relative to the linkage.

### CROSS-REFERENCE TO RELATED APPLICATION

This application claims the benefit from U.S. Provisional Patent Application No. 61/515,678 entitled “Cargo Accessory Folding Mechanism” filed on Aug. 5, 2011, which is hereby incorporated in its entirety by reference.

### TECHNICAL FIELD

The present invention generally relates to a folding mechanism and, more particularly, to a folding mechanism for a cargo accessory.

### BACKGROUND

Vehicles are available in many different shapes and sizes. Vehicles, regardless of their shape or size have a limit on the amount of cargo space available within the vehicle. In order to expand upon this limited cargo space, cargo management systems have been developed to help create additional cargo capacity for a vehicle. These cargo management systems are typically capable of carrying additional items in a predetermined manner, relieving vehicles of some of their cargo restraints.

Many of the available cargo management systems attach to the exterior of the vehicle and are carried outside of the vehicle. One common type of cargo management system is one that attaches to a hitch receiver, which is attached to the vehicle. The hitch receiver often attaches to the frame of the vehicle and may extend immediately below the bumper of the vehicle from the rear thereof. When used with a hitch receiver, cargo management systems often utilize a draw bar that is selectively attached to the hitch receiver securing such to the vehicle. More specifically, certain cargo management systems may utilize a draw bar that attaches to a matingly shaped hitch receiver.

These cargo management systems may then extend from the rear of the vehicle. This, however, may result in the vehicle being more difficult to park, maneuver, and the like. In such situations, the cargo management system may need to be removed from the vehicle in order to park or effectively maneuver the vehicle. This, however, can be time consuming and may require the cargo management system to be stored, which may not be feasible.

Alternatively, some cargo management systems are capable of being re-positioned while remaining secured to the vehicle. These systems, however, often require the user to go between the cargo management system and the vehicle to re-position the cargo management system, which is often difficult to do. Further, these systems are often very difficult to re-position, require more than one person to re-position, or require the removal of the system from the vehicle before being re-positioned.

Therefore, there is a need for a cargo management system that is easier to move to a storage position and that does not require a user to be positioned between the cargo management system and the vehicle to do so. Further, there is a need for a cargo management system that can be re-positioned out of the way when the vehicle to which it is attached is being parked, especially in a garage, a parking spot, or the like. Still further, there is a need for a system that can reposition the cargo management system without having to be removed from the vehicle and can be accomplished by a single user.

### DESCRIPTION OF THE DRAWINGS

The operation of the invention may be better understood by reference to the following detailed description taken in connection with the following illustrations, wherein:

FIG. 1 is a perspective view a cargo accessory attached to a vehicle, the cargo accessory having a folding mechanism.

FIG. 2 is perspective view of the cargo accessory with the folding mechanism.

FIG. 3 is an exploded perspective view of the cargo accessory with the folding mechanism.

FIG. 4 is a perspective view of a folding mechanism for a cargo accessory.

FIG. 5 is cross-sectional view of the folding mechanism of FIG. 3 taken along line 5-5.

FIG. 6 is a plan view of the cross-sectional view of the folding mechanism of FIG. 4.

FIG. 7 is an elevation view of a cross-sectional view of the folding mechanism of FIG. 4 along line 7-7 and a basket of the cargo accessory.

FIG. 8 is an elevation view of a cross-sectional view of the folding mechanism of FIG. 4 along line 7-7 and the basket of the cargo accessory in a first position and phantomed in a second position.

FIG. 9 is an exploded view of a handle of a folding mechanism.

FIG. 10 is a perspective view of embodiments of a cargo accessory with a folding mechanism.

FIG. 11 is a cross-sectional view of the cargo accessory with the folding mechanism of FIG. 10.

FIG. 12 is an elevation view of the cargo accessory with folding mechanism of FIG. 10.

### SUMMARY

A folding mechanism for a cargo accessory is shown and described. The folding mechanism may include a linkage selectively attachable to a vehicle, and a cargo accessory carrying member pivotally attached to the linkage, where the cargo accessory carrying member is capable of locking engagement with the linkage. The folding mechanism may also include a release member operatively attached to the cargo accessory carrying member, where the release member is selectively axially positionable from a first position whereby the cargo accessory carrying member releases from the locking engagement with the linkage permitting pivoting of the cargo accessory carrying member relative to the linkage.

A folding mechanism for a cargo accessory may include a cargo accessory carrying member selectively attachable and pivotable relative to a vehicle, a handle operatively coupled with the cargo accessory carrying member and a release assembly positioned within at least a portion of the cargo accessory carrying member and operatively attached to the handle. The folding mechanism for the cargo accessory may also include a locking member operatively secured with the release member, where the release member is selectively positionable from a first locking position within the locking member preventing the cargo accessory carrying member from pivoting relative to the vehicle and selectively positionable to a pivoting position on the locking member releasing the cargo accessory member to pivot relative to the vehicle.

A folding mechanism for a cargo accessory may include a linkage selectively attachable to a vehicle, a cargo accessory carrying member pivotally attached to the linkage, and a handle operatively coupled with the cargo carrying assembly. The folding mechanism for the cargo accessory may also include a locking member operatively positioned relative to the linkage, and a release member operatively attached to the handle and the locking member, where axially positioning the handle in a first position disengages the release member from engagement with the locking member permitting pivoting of the release member relative to the locking member.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

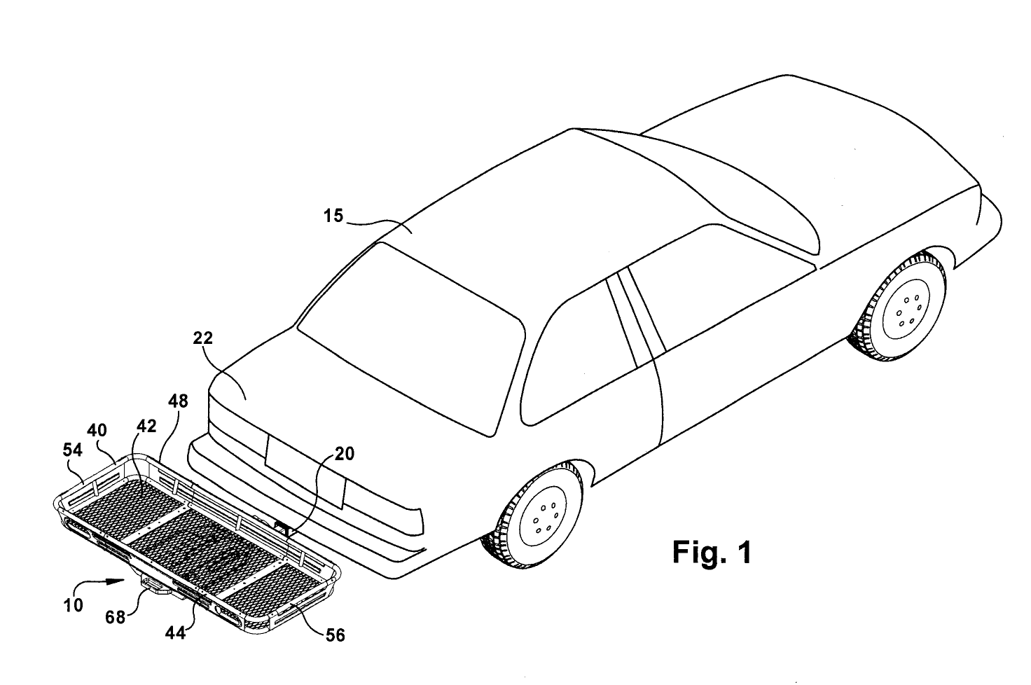

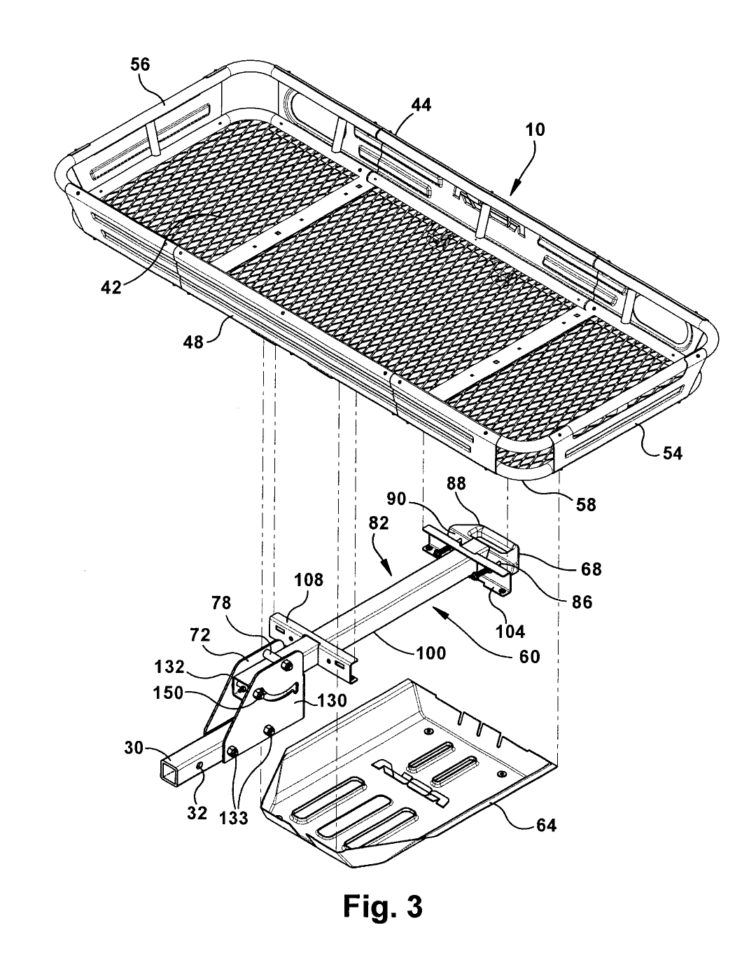

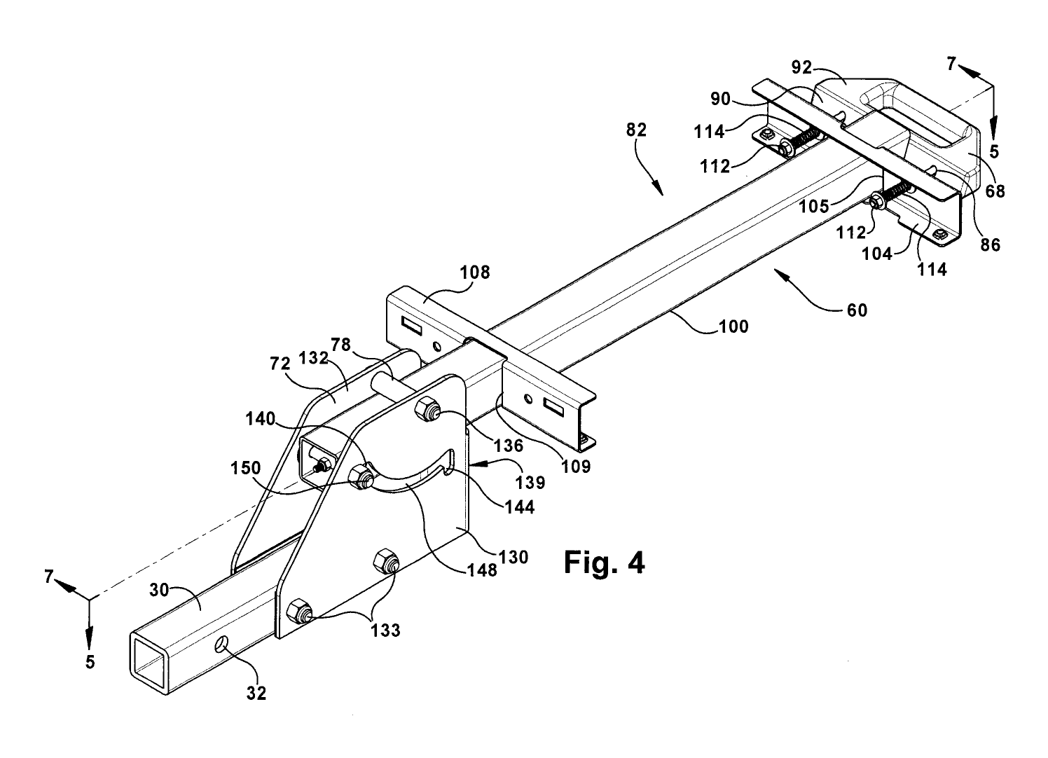

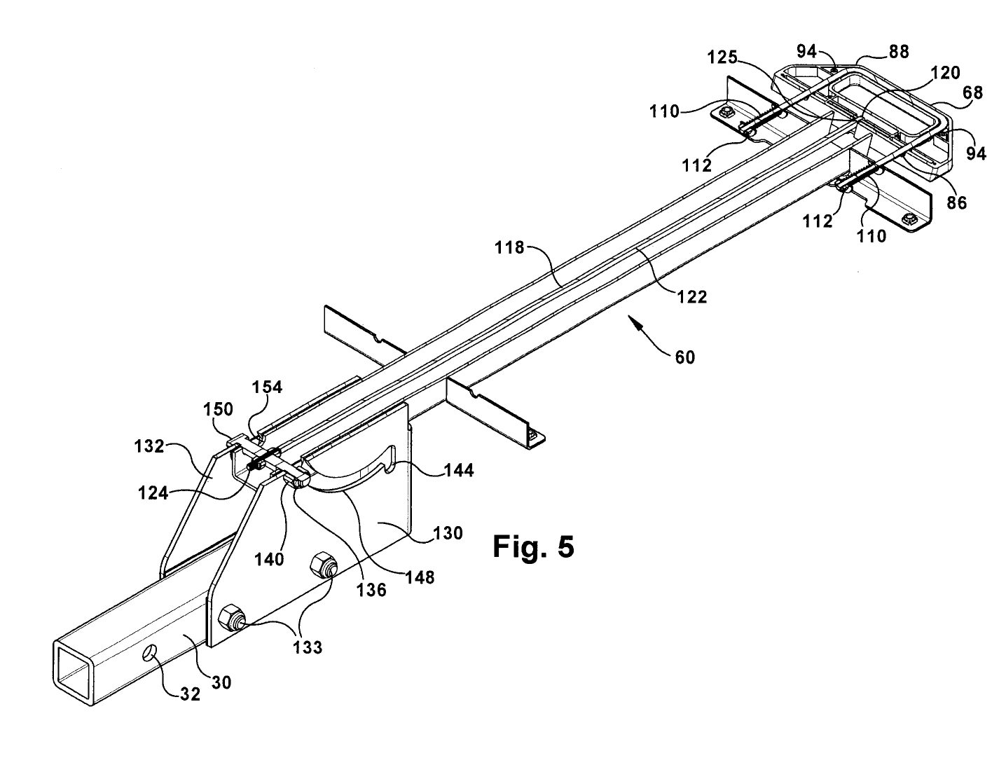

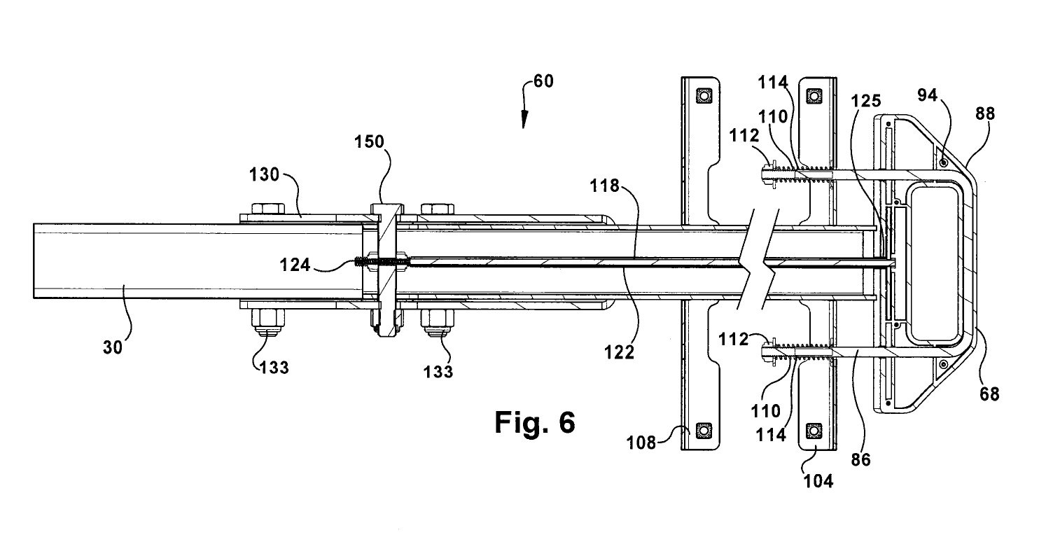

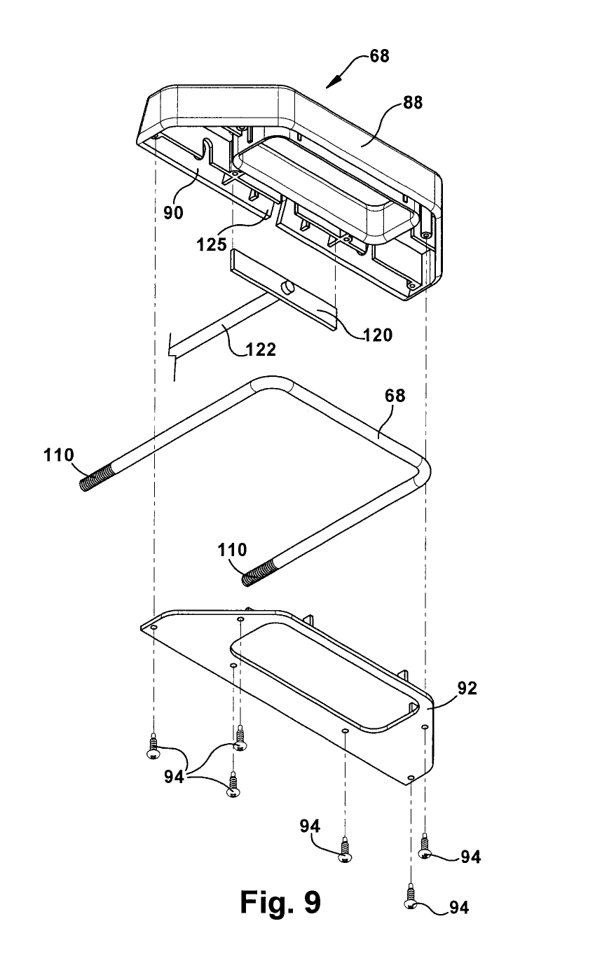

A cargo management system, such as the cargo accessory 10 depicted in FIGS. 1-9, may be capable of selectively attaching to a vehicle 15 in any appropriate manner. By way of a non-limiting example, the cargo accessory 10 may be attached to a hitch receiver 20 that may be secured to a rear portion 22 of the vehicle 15, in any appropriate manner. In these embodiments, the cargo accessory 10 may include a draw bar 30 that may be capable of selectively attaching to the hitch receiver 20 of the vehicle 15 at any appropriate position on the vehicle 15, such as by way of a non-limiting example, the rear portion 22 of the vehicle 15. The cargo accessory 10 may, therefore, extend from the rear portion 22 of the vehicle 15.

The draw bar 30 of the cargo accessory 10 may be capable of selectively engaging the hitch receiver 20 in any appropriate manner. By way of a non-limiting example, the draw bar 30 may include at least one aperture 32 that may be capable of generally aligning with a pin accepting aperture of the hitch receiver 20 upon insertion of the draw bar 30 into the hitch receiver 20. Upon such insertion a hitch pin may be inserted into and through the hitch receiver 20 pin accepting aperture and through the aperture 32, which may selectively secure the cargo accessory 10 with the hitch receiver 30. While the vehicle 15 is shown with the hitch receiver 20 and the cargo accessory is shown with a corresponding draw bar 30, these are exemplary embodiments and not all-inclusive nor exclusive. Any appropriate hitching system, mechanism or other means of attachment to the vehicle 15 may be used without departing from the present teachings.

The cargo accessory 10 may include a basket 40, such as one capable of storing and carrying items. Although, it should be understood that any cargo accessory 10 may be used, not just the basket 40 shown in the drawings. Still further, the basket 40 is not limited to that shown and described. Any appropriate sized and shaped basket may be used without departing from the present teachings. The basket 40 is merely exemplary embodiments and should not be considered to be all-inclusive or exclusive. In alternative embodiments, the cargo accessory 10 may be a pod, a bicycle rack, a cooler accessory, a tool box, a holder for any of the foregoing, or the like.

As depicted in the drawings, the basket 40 may include a storage floor 42, a front portion 44, a rear portion 48, a first side 54, a second side 56, and an underside 58. The front portion 44 may be attached to the first and second side portions 54, 56 in any appropriate manner. Likewise, the rear portion 48 may be attached to the first and second side portions 54, 56 in any appropriate manner. The rear portion 48 of the basket 40 may be adjacent to the rear 22 of the vehicle 15 when the basket 40 is attached to the hitch receiver 20 of the vehicle 15.

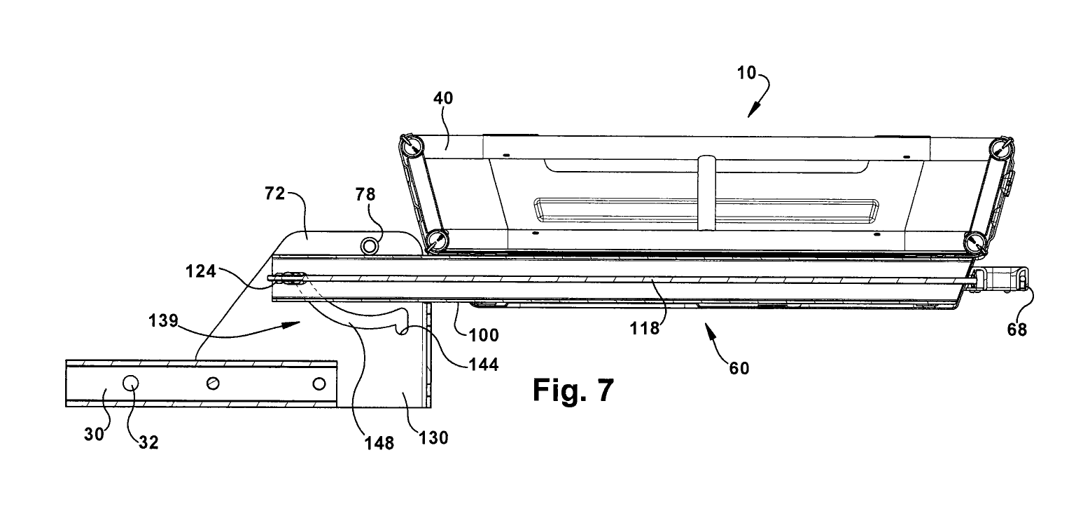

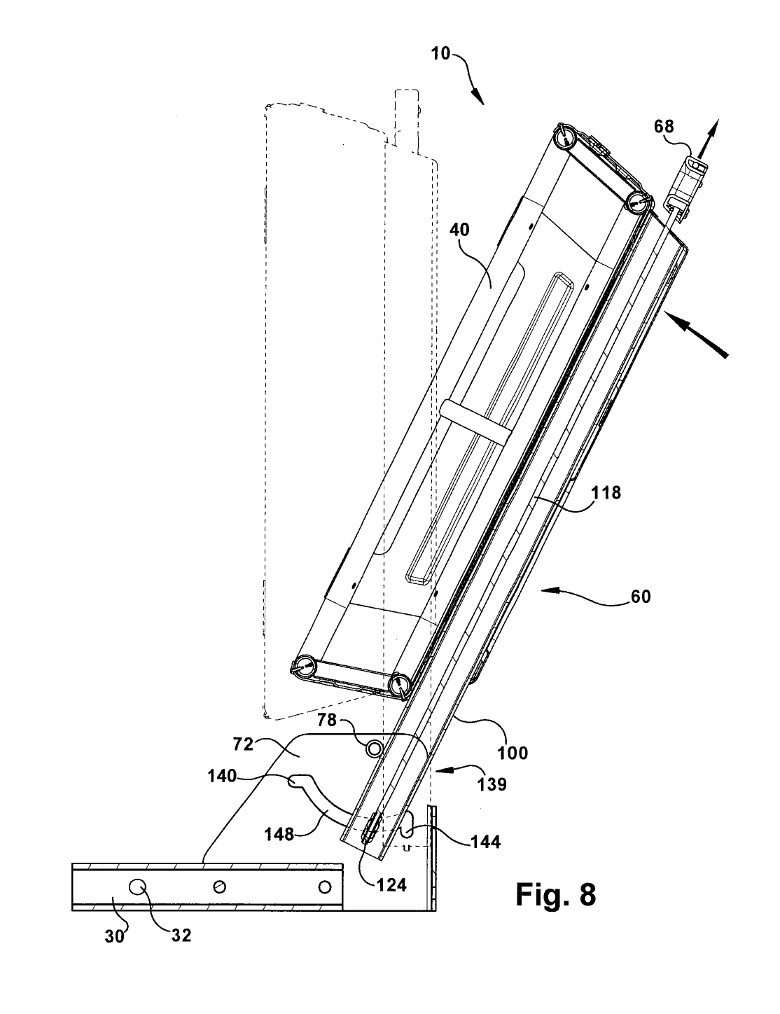

The cargo accessory 10 may include a folding mechanism 60, which may permit the cargo accessory 10 to be selectively positioned between a first position and a second position, as described in more detail below. By way of a non-limiting example, the folding mechanism 60 may permit the cargo accessory 10 to be selectively pivoted between a substantially horizontal position and a substantially vertical position relative to the hitch receiver 20, an example of which is shown in FIGS. 7 and 8.

By way of a non-limiting example, the folding mechanism 60 may be attached to the basket 40, and in particular may be attached to the underside 58 of the basket 40 in any appropriate manner. In some embodiments, a plate 64 may be attached to the underside 58 of the basket 40 substantially encapsulating the folding mechanism 60. This may hide portions of the folding mechanism 60 from the view of the user. This may result in the cargo accessory 10 being more aesthetically pleasing while also potentially protecting the folding mechanism 60 from environmental conditions. However, the plate 64 is optionally may not be used with the present teachings.

The folding mechanism 60 may include a handle 68, a linking device 72, a pivot point 78, and a release mechanism 82. The handle 68 may be positioned in proximity to the front side 44 of the basket 40. This may result in the handle 68 extending from the rear 22 of the vehicle 15 allowing the user clearance to operate the folding mechanism 60 from the rear 22 of the vehicle 15. The position of the handle 68 may allow the user to generally avoid being required to go between the cargo accessory 10 and the vehicle 15 to operate the folding mechanism 60. The handle 68 may be made of any appropriate material, such as by way of a non-limiting example, the handle 68 may be made of nylon.

The handle 68 may include a substantially U-shaped bolt 86 that may extend from a front portion 88 of the handle 68 to a rear portion 90 thereof. The handle 68 may further include a cover 92. The cover 92 may be attached to the handle 68 using fasteners, welding, adhesives or the like. By way of a non-limiting example a plurality of fasteners 94 may be used to secure the cover 92 to the handle 68, which may result in the U-bolt 86 being nestingly supported within the handle 68 and being secured with the handle 68. The cover 92 may generally protect interior components of the handle 68 from environmental conditions, including generally protecting the U-bolt 86 from environmental conditions. The cover 92 may also provide an aesthetically pleasing appearance to the handle 68.

The folding mechanism 60 may further include a tubular member 100 that may be operatively attached to the handle 68 in any appropriate manner. The tubular member 100 may include first and second transverse members 104, 108, which may be attached to the tubular member 100 in any appropriate manner. By way of a non-limiting example, the first and second transverse members 104, 108 may each include apertures 105, 109, respectively. The apertures 105, 109 may be of a shape and size such that the tubular member 100 may be inserted into and through the apertures 105, 109. Upon insertion of the tubular member 100 through the apertures 105, 109, the first and second transverse members 104, 108 may be attached to the tubular member 100 through friction fit alone, welding, adhering, fastening, or any combination of such.

The first and second transverse members 104, 108 may secure the folding mechanism 60 to the underside 58 of the basket 40. More specifically, the first and second transverse members 104, 108 may be attached to the underside 58 of the basket 40 using fasteners, welding, or the like. By way of a non-limiting example, fasteners (not shown) may be used to attach the first and second transverse members 104, 108 to the underside 58 of the basket 40. The basket 40 may be fixedly secured to the first and second transverse members 104, 108 or may be selectively secured to the first and second transverse members 104, 108 such that the basket 40 may be capable of being selectively removed from the folding mechanism 60 and replaced with a cargo carrying system of a different design and purpose.

In some embodiments, the U-bolt 86 may be attached to the first transverse member 104 resulting in the handle 68 being attached to the tubular member 100. More specifically, the U-bolt 86 may include a threaded portion 110 that may extend into and attach with the first transverse member 104 in any appropriate manner. By way of a non-limiting example, corresponding nuts 112 may be capable of engaging the threaded portion 110 of the U-bolt 86 to secure the U-bolt 86 to the first transverse member 104. It should be understood, however, that any appropriate fastening device may be used, not just that shown and described herein.

Further, a biasing member 114, such as a coil spring, may operatively engage the U-bolt 86. By way of a non-limiting example, a pair of biasing members 114 may circumscribe a portion of the U-bolt 86—such as adjacent to, in proximity to or over the threaded portions 110—and be positioned generally between the nut 112 and the first transverse member 104. Any appropriate number of biasing members 114 may be used without departing from the present teachings, e.g., one, three, etc. Further, while a coil spring is shown and described, the biasing member 114 is not limited to being a coil spring, but may comprise any appropriate biasing member that may be capable of applying a biasing force to the U-shaped bolt 86 or more specifically to the handle 68 as described in more detail below.

The release mechanism 82 may be operatively attached to the handle 68 in any appropriate manner. The release mechanism 82 may include an axial movement member 118, which may be operatively attached to the handle 68. By way of a non-limiting example, the axial movement member 118 may be of any appropriate size and shape such as a rod, a cable, or the like. The axial movement member 118 may be of any appropriate materials, such as by way of a non-limiting example, metal, plastics, rubber, a metal wrapped in an appropriate material such as rubber or plastic, or a combination of any of the foregoing.

The axial movement member 118 may include a head 120, a body 122 that may extend from the head 120, and an end portion 124 distal the head 120. The head 120 may be of a shape and size such that it may be operatively secured with the handle 68 in any appropriate manner. By way of a non-limiting example, the head 120 may be inserted into and held within the handle 68. The cover 92 may be attached with the handle 68 such that the head 120 may be nestingly engaged with the handle 68 operatively securing the head 120 with the handle 68. In other embodiments, the head 120 may be attached to the handle 68 through fasteners, welding, adhering or the like. The head 120 being positioned in the handle 68 may attach the axial movement member 118 with the handle 68.

The biasing members 114 may apply a biasing force against axial movement of the head 120 when a user axially positions the handle 68 away from the basket 40. Specifically, the biasing members 114 may apply a biasing force in a direction opposite to the direction of axial movement of the handle 68 such that the biasing members 114 bias the handle 68 and the head 120 into a locked position as more fully described below.

With the head 120 operatively secured with the handle 68, the body 122 may extend from the head 120 through an opening 125 in the handle 68. The body 122 may extend into and through the tubular member 100. The body 122 may be operatively positioned within the tubular member 100 in any appropriate manner. In some embodiments, the body 122, may extend an entire length of the tubular member 100 and may be generally positioned therein. The end portion 124 may be operatively secured to the linkage device 72 as discussed in more detail below. This may result in the head 120 being operatively secured with the handle 68, the body 122 extending from the handle 68 into and through the tubular member 100 and the end portion 124 attached to the linkage device 72. In these embodiments, the body 122 may generally be freely positioned within the tubular member 100 free of contact with the tubular member 100 or may be attached with the tubular member 100 in an appropriate manner.

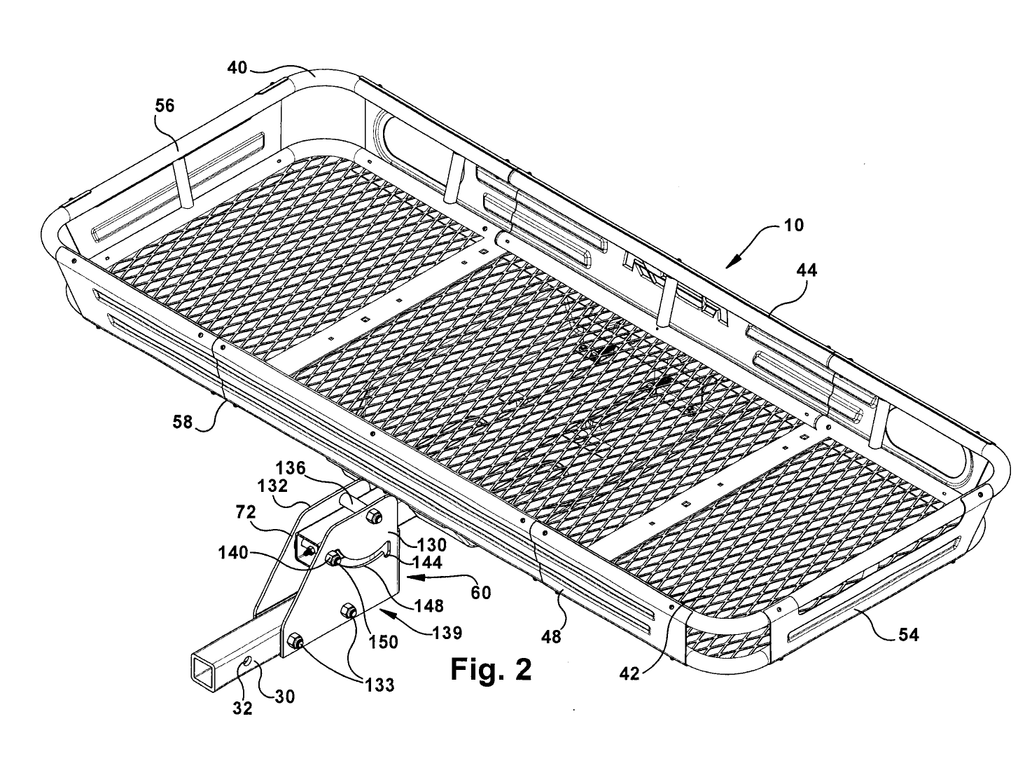

The linkage device 72 may be operatively secured to the tubular member 100 in any appropriate manner and may be secured with the draw bar 30 in any appropriate manner. In a non-limiting example, the linkage device 72 may include first and second plates 130, 132 to the tubular member 100 may be pivotally secured, as further described below. The first and second plates 130, 132 may also be attached to the draw bar 30 such as through using fasteners 133 as shown in FIGS. 2-6. In a non-limiting example, a pair of fasteners 133 may be inserted into and through the first plate 130 through the draw bar 30 and through the second plate 132. This may fixedly secure the linkage device 72 with the draw bar 30. While fasteners 133 are shown and described as securing the linkage device 72 with the draw bar 30, the present teachings are not limited to such—the linkage device 72 may be attached with the draw bar 30, such as welding, adhesives, or any other suitable method.

In some embodiments, the first and second plates 130, 132 may be secured to the tubular member 100 such that the first and second plates 130, 132 are positioned substantially parallel to each other. Further, a rotational member 136 may be attached to the linkage device 72 at the pivot point 78. More specifically, the rotational member 136 may be attached to the first and second plates 130, 132 and may extend therebetween. The rotational member 136 may allow the tubular member 100 to pivot relative to the first and second plates 130, 132. In some embodiments, the rotational member 136 may comprise a fastener 136 that may extend through the first and second plates 130, 132 and may generally rest upon the tubular member 100. This may create the pivot 78, i.e. the tubular member 100 may pivot at 78 relative to the first and second plates 130, 132.

The folding mechanism 60 may further include a locking member 139. The locking member 139 may be on any appropriate position of the folding mechanism 60. By way of a non-limiting example, the locking member 139 may be positioned on the linkage 72 and more specifically may be positioned on the first and second plates 130, 132. While the locking member 139 may be positioned on the linkage 72, and more specifically, the first and second plates 130, 132, the present teachings are not limited to such. The locking member 139 may be in any appropriate position and in some embodiments, may be located separate from the linkage 72.

The locking member 139 may include a first slot 140, a second slot 144 and a rotational groove 148 positioned in the first and second plates 130, 132. The first and second slots 140, 144 and the rotational groove 148 may be integrally formed in the first and second plates 130, 132 or alternatively may be formed therein through a subsequent operation, such as machining such therein. The first and second slots 140, 144 may be of any appropriate shape and size. Similarly, the rotational groove 148 may be of any appropriate shape and size. In some embodiments, the first and second slots 140, 144 may be of a shape and size such that a transverse fastener 150 (which is described in more detail below) may be positioned therethrough. Similarly, the rotational groove 148 may of a shape and size such that the transverse fastener 150 may be positioned therethrough. Still further, in some embodiments, the first and second slots 140, 144 may be of generally a same size and may be generally the same size as the rotational groove 148. In other embodiments, at least one of, a plurality of or all of the first and second slots 140, 144 and the rotational groove 148 may be of a generally different size. The present teachings are not limited to such. While the first and second slots 140, 144 and rotational groove 148 are shown in both the first and second plates 130, 132 the present teachings are not limited to such. In some embodiments only one of the first or second plates 130, 132 may include the first and second slots 140, 144 and the rotational groove 148.

The linkage device 72 may include the transverse fastener 150 as noted above. The transverse fastener 150 may extend through the first and second plates 130, 132 and through the tubular member 100, or more specifically through a slot 154 in the tubular member 100. The transverse fastener 150 may be selectively positionable between the first and second slots 140, 144 via the rotational groove 148. In a non-limiting example, the end portion 124 of the axial movement member 118 may be attached to the transverse fastener 150 in any appropriate manner. The axial movement member 118 may be capable of selectively positioning the transverse fastener 150 from either of said first and second slots 140, 144 and into the rotational groove 148. More specifically, the transverse fastener 150 may be capable of being selectively positioned from and to the first slot 144 through the rotational groove 148 and to and from the second slot 144 as the tubular member 100 pivots at pivot 78. This may then allow the folding mechanism 60 to move the cargo accessory 10 from a substantially horizontal position to a substantially vertical position and then back.

The transverse fastener 150 may be positioned from either of the first or second slots 140, 144 by axially moving the handle 68 against the biasing of the biasing members 114. The handle 68 being axially moved may axially move the head 120, which may axially position the body 122 and the end portion 124 thereof As the end portion 124 may be operatively secured with the transverse fastener 150, the transverse fastener 150 may be positioned from either of the first or second slots 140, 144 against the biasing of the biasing members 114. Doing so may allow the folding mechanism 60 to pivot around pivot point 78 from a generally horizontal position to a generally vertical position and back to the generally horizontal position. The transverse fastener 150 being positioned in the first slot 140 may generally lock the folding mechanism 60 in the generally horizontal position whereas the transverse fastener 150 being positioned in the second slot 144 may generally lock the folding mechanism 60 in the generally vertical position. The biasing force applied by the biasing member 114 may further secure the transverse fastener 150 in either of the first or second slots 140, 144.

The folding mechanism 60 may operate by pulling the handle 68 that may be connected to the axial movement member 118, which may pull the axial movement member 118 in substantially the same direction as the handle 68. Axially moving the axial movement member 118 may cause the transverse fastener 150 to release from either of the first or second slot 140, 144 and into the rotational groove 148. The transverse fastener 150 being in the rotational groove 148 may then permit the tubular member 100 to pivot relative to the linkage device 72 around pivot 78. This may permit the folding mechanism 60 to pivot the basket 40 from a first position to a second position. By way of a non-limiting example, the basket 40 may pivot from a substantially horizontal position to a substantially vertical position and then back to the substantially horizontal position. When the handle 68 is released the transverse fastener 150 may then be capable of moving into either of the first or second slot 140, 144 locking the basket 40 into either of the vertical position or horizontal position, as applicable. This may then secure the cargo accessory 10, and more particularly, the basket 40 in either of the first or second positions, e.g., the horizontal or vertical positions.

Additional embodiments of a folding mechanism for a cargo accessory according the present teachings are described below. In the descriptions, all of the details and components may not be fully described or shown. Rather, the features or components are described and, in some instances, differences with the above-described embodiments may be pointed out. Moreover, it should be appreciated that these additional embodiments may include elements or components utilized in the above-described embodiments although not shown or described. Thus, the descriptions of these additional embodiments are merely exemplary and not all-inclusive nor exclusive. Moreover, it should be appreciated that the features, components, elements and functionalities of the various embodiments may be combined or altered to achieve a desired folding mechanism for a cargo accessory without departing from the spirit and scope of the present teachings.

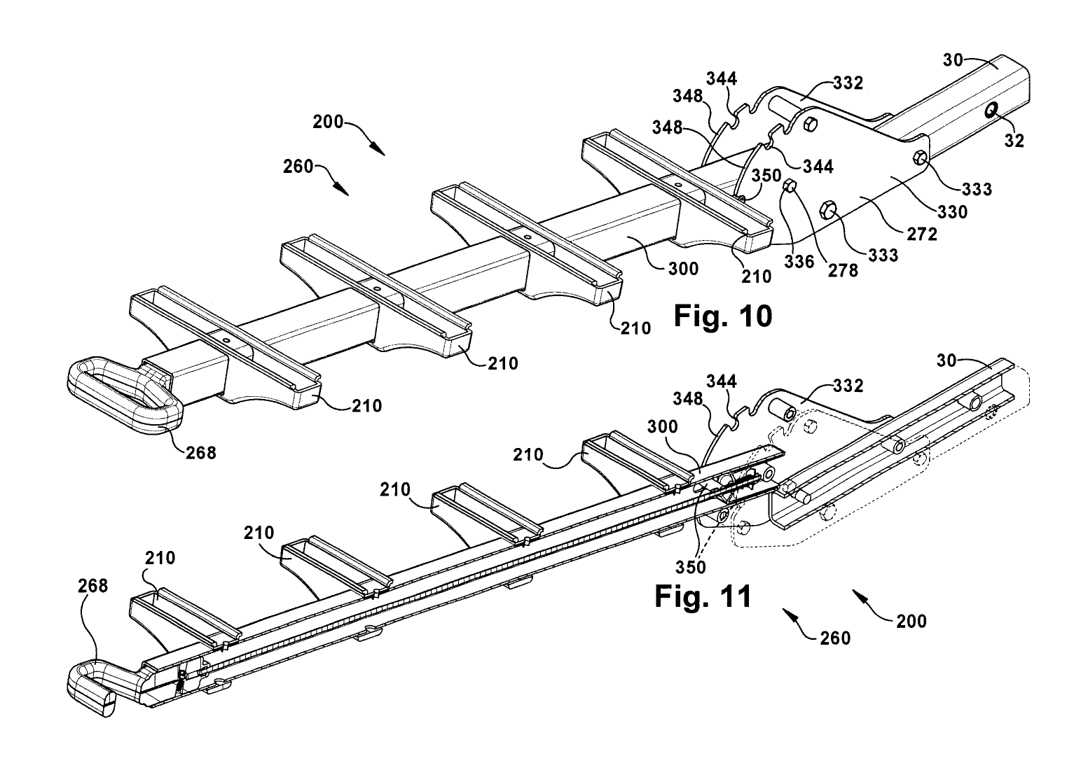

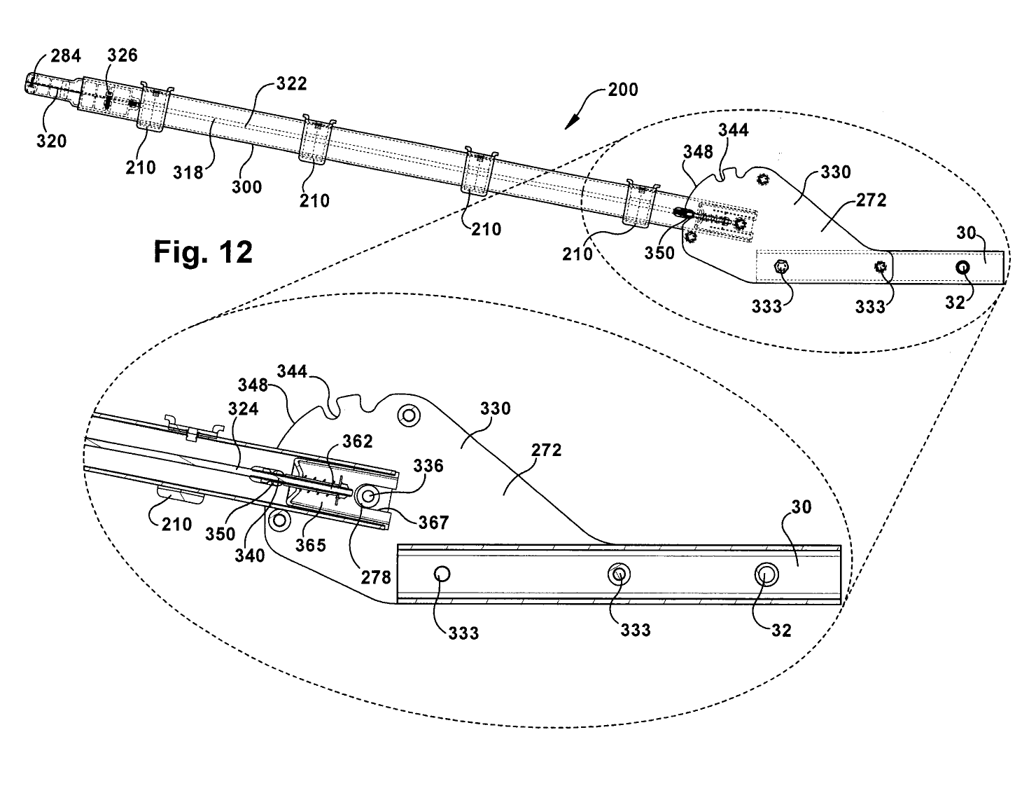

A cargo management system, such as the cargo accessory 200 depicted in FIGS. 10-11, may be capable of selectively attaching to a vehicle 15 in any appropriate manner. The cargo accessory may include at least one bike holder 210—although four bike holders 210 are shown. While four bike holders 210 are shown in the drawings, any number of such may be used without departing from the present teachings. By way of non-limiting examples, one, two, three or more bike holders 210 may be used. Still further, while a bike holder is shown as the accessory attaching device, any kind of accessory attaching device may be used without departing from the present teachings.

The cargo accessory 200 may include a folding mechanism 260. The bike holders 210 may be operatively coupled with the folding mechanism 260 in any appropriate manner, such as via fastening, welding, adhering or the like.

The folding mechanism 260 may include a handle 268, a linking device 272, a pivot point 278, and a release mechanism 282. The handle 268 may be positioned distal to the linking device 272 that may be selectively secured to the vehicle 15. This may result in the handle 268 extending from the rear 22 of the vehicle 15 allowing the user clearance to operate the folding mechanism 260 from the rear 22 of the vehicle 15. The position of the handle 268 may allow the user to generally avoid being required to go between the cargo accessory 200 and the vehicle 15 to operate the folding mechanism 260. The handle 268 may be made of any appropriate material, such as by way of a non-limiting example, the handle 268 may be made of nylon. The handle 268 may include an attachment member 284 that may be positioned within the handle 268; the details of which are described in more detail below. The attachment member 284 may be operatively secured to the release mechanism 282.

The folding mechanism 260 may further include a tubular member 300 that may be operatively attached to the handle 268 in any appropriate manner. The tubular member 300 may have attached thereto the bike holders 210. By way of a non-limiting example, four bike holders 210 may be secured to the tubular member 300 and may be spaced apart from one another. However, the present teachings are not limited to bike holders 210. Any kind of accessory securing or carrying device may be used and may be attached to the tubular member 300. The tubular member 300 may secure the bike holders 210 to the folding mechanism 260 in any appropriate manner, such as by using fasteners, welding, or the like. The tubular member 300 may be of substantially the same configuration as the tubular member 100 or may be of a different configuration. The present teachings are not limited to the configurations shown.

The release mechanism 282 may be operatively attached to the handle 268 in any appropriate manner. The release mechanism 282 may include an axial movement member 318, which may be operatively attached to the handle 268. By way of a non-limiting example, the axial movement member 318 may be of any appropriate size and shape such as a rod, a cable, or the like. The axial movement member 318 may be of any appropriate materials, such as by way of a non-limiting example, metal, plastics, rubber, a metal wrapped in an appropriate material such as rubber or plastic, or a combination of any of the foregoing.

The axial movement member 318 may include a head 320, a body 322 that may extend from the head 320, and an end portion 324 distally positioned from the head 320. The head 320 may be of a shape and size such that may be operatively secured with the handle 268 in any appropriate manner. By way of a non-limiting example, the head 320 may be inserted into and held within the handle 268. The attachment member 284 may be operatively secured to the head 320. In other embodiments, the head 320 may include a fastener 326, which may be attached to the handle 268. An attachment member 327 may be attached between the fastener 284 and the fastener 326, which may operatively secure the axial movement member 318 with the handle 268.

With the head 320 operatively secured with the handle 268, the body 322 may extend from the head 320 into and through the tubular member 300. The body 322 may be operatively positioned within the tubular member 300 in any appropriate manner. In some embodiments, the body 322, may extend an entire length of the tubular member 300 and may be generally positioned therein. The end portion 324 may be operatively secured to the linkage device 272 as discussed in more detail below. This may result in the head 320 being operatively secured with the handle 268, the body 322 extending from the handle 268 into and through the tubular member 300 and the end portion 324 attached to the linkage device 272. In these embodiments, the body 222 may generally be freely positioned within the tubular member 300 free of contact with the tubular member 300 or may be attached thereto in any appropriate manner.

The linkage device 272 may be operatively secured to the tubular member 300 in any appropriate manner and may be secured with the draw bar 30 in any appropriate manner. In a non-limiting example, the linkage device 272 may include first and second plates 330, 332. The tubular member 300 may be pivotally secured to the first and second plates 330, 332, as further described below. The first and second plates 330, 332 may also be attached to the draw bar 30 such as through using fasteners 333 as shown in FIG. 11. In a non-limiting example, a pair of fasteners 333 may be inserted into and through the first plate 330 through the draw bar 30 and through the second plate 332. This may fixedly secure the linkage device 272 with the draw bar 30. While fasteners 333 are shown and described as securing the linkage device 272 with the draw bar 30, the present teachings are not limited to such—the linkage device 272 may be attached with the draw bar 30, such as through welding, adhesives, or any other suitable method.

In some embodiments, the first and second plates 330, 332 may be secured to the tubular member 100 such that the first and second plates 330, 332 are positioned substantially parallel to each other, but the present teachings are not limited to this configuration. A rotational member 336 may be attached to the linkage device 272 at the pivot point 278. More specifically, the rotational member 336 may be attached to the first and second plates 330, 332 and through the tubular member 300. The rotational member 336 may allow the tubular member 300 to pivot relative to the first and second plates 330, 332 at the pivot point 278. In some embodiments, the rotational member 336 may comprise a fastener 336 that may extend through the first and second plates 330, 332 and through the tubular member 300. This may create the pivot 278, i.e. the tubular member 300 may pivot at 278 relative to the first and second plates 330, 332.

The folding mechanism 260 may further include a locking member 339. The locking member 339 may be on any appropriate position of the folding mechanism 260. By way of a non-limiting example, the locking member 339 may be positioned on the linkage 272 and more specifically may be positioned on the first and second plates 330, 332. While the locking member 339 may be positioned on the linkage 272, and more specifically, the first and second plates 330, 332, the present teachings are not limited to such. The locking member 339 may be in any appropriate position and in some embodiments, may be located separate from the linkage 272.

The locking member 339 may include a first slot 340, a second slot 344 and a camming surface 348 positioned therebetween. The first and second lots 340, 344 and the camming surface 348 may all be positioned on the first and second plates 330, 332. The first and second slots 340, 344 and the camming surface 348 may be integrally formed in the first and second plates 330, 332 or alternatively may be formed therein through a subsequent operation, such as machining such therein. The first and second slots 340, 344 may be of any appropriate shape and size. In some embodiments, the first and second slots 340, 344 may be of a shape and size such that a transverse fastener 350 (which is described in more detail below) may be positionable therein and secured within the applicable slots 340, 344. The camming surface 348 may of a shape and size such that the transverse fastener 350 may be capable of riding thereon between the first and second slots 340, 344. Still further, in some embodiments, the first and second slots 340, 344 may be of generally a same size. In other embodiments, the first and second slots 340, 344 may be of different sizes. While the first and second slots 340, 344 and camming surface 348 are shown in both the first and second plates 330, 332 the present teachings are not limited to such. In some embodiments only one of the first or second plates 330, 332 may include the first and second slots 340, 344 and the camming surface 348.

The linkage device 272 may include the transverse fastener 350 as noted above. The transverse fastener 350 may extend through the tubular member 300. The tubular member 300 may include a slot 354 through which the transverse fastener 350 may extend. The slot 354 may be of a shape and size such that the transverse fastener 350 may be axially displaceable from a first position to a second position within the slot 354 as described in more detail below.

The transverse fastener 350 may be selectively positionable between the first and second slots 340, 344 via the camming surface 348. In a non-limiting example, the end portion 324 of the axial movement member 318 may be attached to the transverse fastener 350 such that the axial movement member 318 may selectively position the transverse fastener 350 from either of the first and second slots 340, 344 such that the transverse member 350 may be positioned to and along the camming surface 348. More specifically, the transverse fastener 350 may be capable of being selectively positioned from and to the first slot 344 along the camming surface 348 and to and from the second slot 344 as the tubular member 300 pivots at pivot 278. This may then allow the folding mechanism 260 to move the cargo accessory 200 from a first position to a second position and back, e.g., a substantially horizontal position to a substantially vertical position and then back. The transverse fastener 350 may be attached to the end portion 324 of the axial movement member 318 such that axial movement of the handle 268 may axially move the transverse fastener 350 within the slot 354 of the tubular member 300.

A biasing member 362 may be operatively attached to the transverse fastener 350 in any appropriate manner. In some embodiments, the biasing member 362 may be positioned between the transverse fastener 350 and the end portion 324 of the axial movement member 318. In some embodiments, the biasing member 362 may attached between the transverse fastener 350 and the fastener 336—which is the rotational member 336. By way of a non-limiting example, an attachment member 365 may be positioned at an end 367 of the tubular member 300. The attachment member 365 may engage the end 367 of the tubular member 300 and the biasing member 362 may be operatively secured between the attachment member 365 and the transverse fastener 350. The biasing member 362 may bias the axial movement member 318 toward a locked position, e.g., the biasing member 362 may bias the transverse member 350 toward and into at least one of the first and second slots 340, 344, as described in more detail below.

The transverse fastener 350 may be positioned from either of the first or second slots 340, 344 by axially moving the handle 268 against the biasing of the biasing members 362. The handle 268 may be axially positioned, which may move the head 320, which may axially position the body 322 and the end portion 324. As the end portion 324 may be operatively secured with the transverse fastener 350, the transverse fastener 350 may be positioned from either of the first or second slots 340, 344 against the biasing of the biasing members 362 along slot 354. Doing so may allow the folding mechanism 260 to pivot around pivot point 278 from a generally horizontal position to a generally vertical position and back to the generally horizontal position. The transverse fastener 350 being positioned in the first slot 340 may generally lock the folding mechanism 260 in a first position, e.g., the generally horizontal position whereas the transverse fastener 350 being positioned in the second slot 344 may generally lock the folding mechanism 260 in a second position, e.g., the generally vertical position.

The folding mechanism 260 may operate by pulling the handle 268 that may be connected to the axial movement member 318, which may pull the axial movement member 318 in substantially the same direction as the handle 368. Axially moving the axial movement member 318 may cause the transverse fastener 350 to release from either of the first or second slot 340, 344, as applicable. The folding mechanism 260 may then be pivoted relative to the pivot point 278 and the transverse fastener 350 may then be capable of engaging and moving along the camming surface 348. The transverse fastener 350 being on the camming surface 348 may permit the tubular member 300 to pivot relative to the linkage device 272, which may permit the folding mechanism 260 to pivot the bike holders 210 from the first position to the second position. By way of a non-limiting example, the bike holders 210 may pivot from a substantially horizontal position—which may be a bike hauling position—to a substantially vertical position—which may be a storage position. The steps may be reversed to go from the vertical position to the horizontal position as desired. When the handle 268 is released the transverse fastener 350 may then be capable of moving into either of the first or second slot 340, 344 locking the bike holders 210 into either of the vertical position or horizontal position, as applicable.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, the following is claimed:

1. A folding mechanism for a cargo accessory, the folding mechanism comprising:
a linkage selectively attachable to a vehicle;
a cargo accessory carrying member pivotally attached to the linkage, wherein the cargo accessory carrying member is capable of locking engagement with the linkage; and
a release member operatively attached to the cargo accessory carrying member, wherein the release member is selectively axially positionable from a first position whereby the cargo accessory carrying member releases from the locking engagement with the linkage permitting pivoting of the cargo accessory carrying member relative to the linkage.

2. The folding mechanism of claim 1, wherein the release member is axially positionable to a second position whereby the cargo accessory carrying member is in the locking engagement with the linkage substantially preventing pivoting of the cargo accessory carrying member relative to the linkage

3. The folding mechanism of claim 2, further comprising a locking member operatively secured with the release member, wherein the release member is selectively positionable from at least one engaging position in the locking member preventing the cargo accessory carrying member from pivoting relative to the linkage and selectively positionable to at least one released position on the locking member releasing the cargo accessory member to pivot relative to the linkage.

4. The folding mechanism of claim 3, wherein the locking member is positioned on the linkage.

5. The folding mechanism of claims 1, 2, 3, or 4, further comprising a handle operatively secured with the release member wherein the handle is axially positionable causing the release member to axially position from the first position.

6. The folding mechanism of claim 5, wherein the release member includes a rod and a transverse member.

7. The folding mechanism of claim 6, wherein the locking member includes first and second engagement members formed in the linkage.

8. The folding mechanism of claim 7, wherein the first and second engagement members include first and second slots formed in the linkage.

9. The folding mechanism of claim 8, wherein the locking member further includes a rotational slot positioned between the first and second slots and formed in the linkage.

10. The folding mechanism of claim 9, wherein the transverse member being in the first slot generally locks the cargo accessory carrying member in a generally horizontal position and the transverse member being in the second slot generally locks the cargo accessory carrying member in a generally vertical position.

11. The folding mechanism of claim 10, wherein the transverse member is selectively positionable from the first slot to the rotational slot upon axial movement of the rod.

12. The folding mechanism of claim 11, wherein the transverse member is selectively positionable from the second slot to the rotational slot upon axial movement of the rod.

13. The folding mechanism of claim 12, wherein the cargo accessory carrying member is pivotably relative to the linkage with the transverse member in the rotational slot.

14. The folding mechanism of claim 8, wherein the locking member further includes a camming surface positioned between the first and second slots and formed in the linkage.

15. The folding mechanism of claim 14, wherein the transverse member being in the first slot generally locks the cargo accessory carrying member in a generally horizontal position and the transverse member being in the second slot generally locks the cargo accessory carrying member in a generally vertical position.

16. The folding mechanism of claim 15, wherein the transverse member is selectively positionable from the first slot to the camming surface upon axial movement of the rod.

17. The folding mechanism of claim 16, wherein the transverse member is selectively positionable from the second slot to the camming surface upon axial movement of the rod.

18. The folding mechanism of claim 14, wherein the cargo accessory carrying member is pivotably relative to the linkage with the transverse member operatively positioned on the camming surface.

19. The folding mechanism of claims 8, 9, 10, 11, 12, 13, 14, 15, 16, 17, or 18 wherein the transverse member being in the first or second slot prevents pivoting of the cargo accessory carrying member.

20. A folding mechanism for a cargo accessory, the folding mechanism comprising:
a cargo accessory carrying member selectively attachable and pivotable relative to a vehicle;
a handle operatively coupled with the cargo accessory carrying member;
a release assembly positioned within at least a portion of the cargo accessory carrying member and operatively attached to the handle; and
a locking member operatively secured with the release member, wherein the release member is selectively positionable from a first locking position within the locking member preventing the cargo accessory carrying member from pivoting relative to the vehicle and selectively positionable to a pivoting position on the locking member releasing the cargo accessory member to pivot relative to the vehicle.

21. The folding mechanism of claim 20, wherein the release member is selectively positionable within a second locking position in the locking member preventing the cargo accessory carrying member from pivoting relative to the vehicle.

22. The folding mechanism of claim 21, wherein the handle and release assembly are axially positionable relative to the cargo accessory carrying member whereby axially positioning the handle in a first location releases the release assembly from selective positioning within the first locking position.

23. The folding mechanism of claim 22, wherein the handle and release assembly are axially positionable relative to the cargo accessory carrying member whereby axially positioning the handle in the first location releases the release assembly from selective positioning within the second locking position.

24. The folding mechanism of claim 23, wherein the release member includes a rod positioned within the cargo accessory carrying member and a transverse member extending through the cargo accessory carrying member.

25. The folding mechanism of claim 24, wherein the locking member includes first and second slots formed in the linkage and a rotational slot positioned between the first and second slots and formed in the linkage.

26. The folding mechanism of claim 24, wherein the locking member includes first and second slots formed in the linkage and a camming surface positioned between the first and second slots and formed in the linkage.

27. The folding mechanism of claims 25 or 26, wherein the transverse member being in the first slot generally locks the cargo accessory carrying member in a generally horizontal position and the transverse member being in the second slot generally locks the cargo accessory carrying member in a generally vertical position.

28. A folding mechanism for a cargo accessory, the folding mechanism comprising:
a linkage selectively attachable to a vehicle;
a cargo accessory carrying member pivotally attached to the linkage;
a handle operatively coupled with the cargo carrying assembly;
a locking member operatively positioned relative to the linkage; and
a release member operatively attached to the handle and the locking member, wherein axially positioning the handle in a first position disengages the release member from engagement with the locking member permitting pivoting of the release member relative to the locking member.

29. The folding mechanism of claim 28, wherein the release member is capable of pivoting relative to the locking member into engagement with the locking member whereby the release member is axially displaced to a second position.

30. The folding mechanism of claim 29, wherein the locking member includes first and second engagement members formed in the linkage.

31. The folding mechanism of claim 30, wherein the first and second engagement members include first and second slots formed in the linkage.

32. The folding mechanism of claim 31, wherein the locking member further includes a rotational slot positioned between the first and second slots and formed in the linkage.

33. The folding mechanism of claim 32, wherein a portion of the release member being in the first slot generally locks the cargo accessory carrying member in a generally horizontal position and the portion of the release member being in the second slot generally locks the cargo accessory carrying member in a generally vertical position.

34. The folding mechanism of claim 33, wherein the portion of the release member is selectively positionable from the first slot to the rotational slot upon axial positioning of the handle in the first position.

35. The folding mechanism of claim 34, wherein the portion of the release member is selectively positionable from the second slot to the rotational slot upon axial positioning of the release member in the first position.

36. The folding mechanism of claim 35, wherein the cargo accessory carrying member is pivotably relative to the linkage with the portion of the release member in the rotational slot.

37. The folding mechanism of claim 31, wherein the locking member further includes a camming surface positioned between the first and second slots and formed in the linkage.

38. The folding mechanism of claim 37, wherein a portion of the release member being in the first slot generally locks the cargo accessory carrying member in a generally horizontal position and the portion of the release member being in the second slot generally locks the cargo accessory carrying member in a generally vertical position.

39. The folding mechanism of claim 38, wherein the portion of the release member is selectively positionable from the first slot to the camming surface upon axial positioning of the release member in the first position.

40. The folding mechanism of claim 39, wherein the portion of the release member is selectively positionable from the second slot to the camming surface upon axial positioning of the release member in the first position.

41. The folding mechanism of claim 40, wherein the cargo accessory carrying member is pivotably relative to the linkage with the portion of the release member operatively positioned on the camming surface.

42. The folding mechanism of claims 33, 34, 35, 36, 38, 40, or 41 wherein the portion of the release member being in the first or second slot generally prevents pivoting of the cargo accessory carrying member.

43. The folding mechanism of claim 28, wherein the cargo accessory carrying member includes a generally tubular member.

44. The folding mechanism of claim 43, further comprising a cargo basket attached to the tubular member.

45. The folding mechanism of claim 43, further comprising at least one bike holding member attached to the tubular member.

46. The folding mechanism of claim 43, further comprising a plurality of bike holding members attached to the tubular member.
